(19) United States
(12) Patent Application Publication
(10) Pub. No.: US 2013/0311575 A1
(43) Pub. Date: Nov. 21, 2013

(54) SYSTEMS AND METHODS FOR RECEIVING MULTIPLE USER MESSAGES THAT IDENTIFY A MEDIA ASSET SEGMENT POSITION

(71) Applicants: Thomas Steven Woods, Arlington Heights, IL (US); Brian Craig Peterson, Barrington, IL (US)

(72) Inventors: Thomas Steven Woods, Arlington Heights, IL (US); Brian Craig Peterson, Barrington, IL (US)

(73) Assignee: UNITED VIDEO PROPERTIES, INC., Santa Clara, CA (US)

(21) Appl. No.: 13/472,848

(22) Filed: May 16, 2012

(51) Int. Cl. G06F 15/16

(52) U.S. Cl. 709/206

(57) ABSTRACT

Systems and methods for receiving multiple user messages that identify a media asset segment position are provided. A plurality of messages from a plurality of users is received with a remote server. Each message identifies a segment within the media asset through which a fast-access playback operation was performed. The received messages are processed to extract media asset information and the identified segment. The extracted media asset information of each message is cross-referenced with a media asset information database to identify the media asset that corresponds to each of the received messages. The identified segments extracted from each of the plurality of messages are processed to determine a position of the segment within the identified media asset. The position of the segment within the media asset is stored in the media asset information database for the media asset that corresponds to each of the received messages.

### BACKGROUND

Traditional systems allow users to fast-forward or rewind through a media asset in order to, for example, skip commercials. However, these systems lack an effective mechanism for identifying starting and ending positions of certain media asset portions, such as commercials. Thus, the user is burdened with the tedious task of manually deciding when to start and stop a fast-forward or rewind playback operation to skip over these portions that include commercials.

### SUMMARY

In view of the foregoing, systems and methods for receiving multiple user messages that identify a media asset segment position in accordance with various embodiments of the present invention are provided.

In some embodiments, a remote server may receive a plurality of messages from a plurality of users. Each message may identify a media asset and a segment within the media asset. In particular, the remote server may receive from various user equipment devices identifications of media assets and starting and/or ending positions of segments within the media assets.

The messages transmitted to the remote server by each user equipment device may be automatically generated by each user equipment device. The segment identified by each message may correspond to a plot segment or advertisement portion of the media asset. In some embodiments, the starting and ending positions of the segment identified in each message may be manually identified by the user (e.g., by the user providing input identifying the starting/ending positions of the advertisement or plot portion). In some implementations, the starting and ending positions may be automatically determined by each user equipment device responsive to receiving user requests to perform a fast-access playback operation. For example, the user equipment device may receive a user request to perform a fast-forward playback operation and in response may store as the starting position of the segment the playback position within the media asset when the request was received. In response to receiving a request to end the fast-forward playback operation (e.g., a play command), the user equipment device may store as the ending position of the segment the position within the media asset where playback is resumed or where the stop command was received. The user equipment device may add information identifying the media asset (e.g., a title or unique identifier) to the message and the starting and ending positions.

In some embodiments, the remote server may process the received messages to extract the media asset information and the identified segment. In particular, the remote server may extract each of the starting and ending positions identified by the received messages. The remote server may cross-reference the extracted media asset information of each message with a media asset information database to identify the media asset that corresponds to each of the received messages. Based on the extracted information, the remote server may operate on only those messages that correspond to the same media asset.

The remote server may process the identified segments extracted from each of the plurality of messages to determine a position of the segment within the identified media asset. More specifically, the remote server may extract the starting positions of the segments identified by each message and the ending positions of the segments identified by each message. The remote server may compute an average of all the starting positions of the media asset segments identified by the messages corresponding to the same media asset. Similarly, the remote server may compute an average of all the ending positions of the media asset segments identified by the messages corresponding to the same media asset. The remote server may store as the starting and ending position of the segment the computed average starting and ending positions for the media asset information associated with the media asset corresponding to the received messages.

In some embodiments, a user equipment device may retrieve the media asset for playback. The user equipment device may receive from the remote server information associated with the retrieved media asset that was generated based on the messages received from a plurality of users. The retrieved information may identify one or more segments of the media asset (e.g., plot segments and advertisement segments). In response to receiving a user request to perform a skip or jump segment playback operation (e.g., skip or jump advertisement playback operation), the user equipment device may automatically retrieve the ending position of the segment adjacent to the current playback position. The user equipment device may automatically resume playback from a position corresponding to the ending position of the segment (e.g., the ending position of the advertisement within the media asset) in the case of a forward skip or jump playback operation. The user equipment device may automatically resume playback from a position corresponding to the starting position of the segment (e.g., the starting position of the advertisement within the media asset) in the case of a reverse skip or jump playback operation.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 shows an illustrative display screen of a fast-access playback operation being used to identify a segment position within a media asset in accordance with an embodiment of the invention;

FIG. 6 shows an illustrative display screen of a jump segment or skip segment playback operation being performed on a media asset in accordance with an embodiment of the invention;

FIG. 7 shows an illustrative display screen of performing a jump or skip segment operation using segment position information generated based on input from a plurality of users in accordance with an embodiment of the invention;

FIG. 8 shows illustrative database entries identifying segment positions of stored media assets in accordance with an embodiment of the invention;

FIG. 9 is a diagram of a process for identifying a media asset segment position using messages received from a plurality of users in accordance with embodiments of the invention; and

FIG. 10 is a diagram of a process for jumping over a media asset segment based on information generated using messages received from a plurality of users in accordance with embodiments of the invention.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), messages from a crowd of users on a social network, messages from a crowd of users posted to a blog or website, genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections. In some implementations, this data may be referred to as a data feed. As referred to herein the term “crowd” should be understood to mean any number of users greater than one.

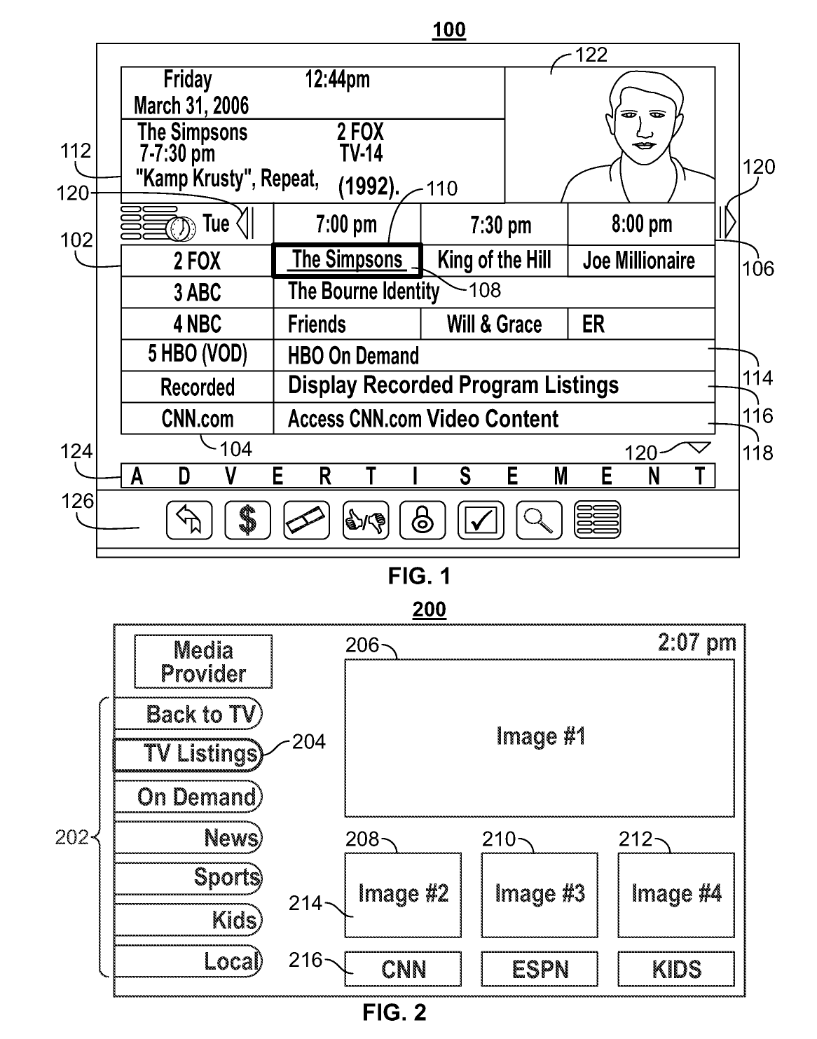

FIGS. 1-2 show illustrative display screens that may be used to provide media guidance data. The display screens shown in FIGS. 1-2 and 5-7 may be implemented on any suitable user equipment device or platform. While the displays of FIGS. 1-2 and 5-7 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

As referred to herein, the phrase “in response” should be understood to mean automatically, directly and immediately as a result of or automatically based on the corresponding action where intervening inputs or actions may occur.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different from display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other airtimes or ways of receiving a program, recording a program, enabling series recording of a program, setting program and/or channel as a favorite, purchasing a program, identifying media asset segment start and end times, performing a fast-access playback operation, performing a jump segment operation or skip commercials operation, or other features. As referred to herein, the term “commercial” should be understood to mean a portion of a media asset that is provided between plot segments of the media asset and/or promotes a media asset, product or service. Options available from a main menu display may include search options, VOD options (e.g., fast-access playback operations), parental control options, Internet options, cloud-based options, device synchronization options, second screen device options, options to access various types of media guidance data displays, options to subscribe to a premium service, options to edit a user's profile, options to access a browse overlay, or other options. As referred to herein, the phrase “fast-access playback operations” should be understood to mean any operation that pertains to playing back a non-linear media asset faster than normal playback speed or in a different order than the media asset is designed to be played, such as a fast-forward, rewind, skip, chapter selection, segment selection, skip segment, jump segment, next segment, previous segment, skip advertisement or commercial, next chapter, previous chapter or any other operation that does not play back the media asset at normal playback speed. The fast-access playback operation may be any playback operation that is not “play,” where the play operation plays back the media asset at normal playback speed.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

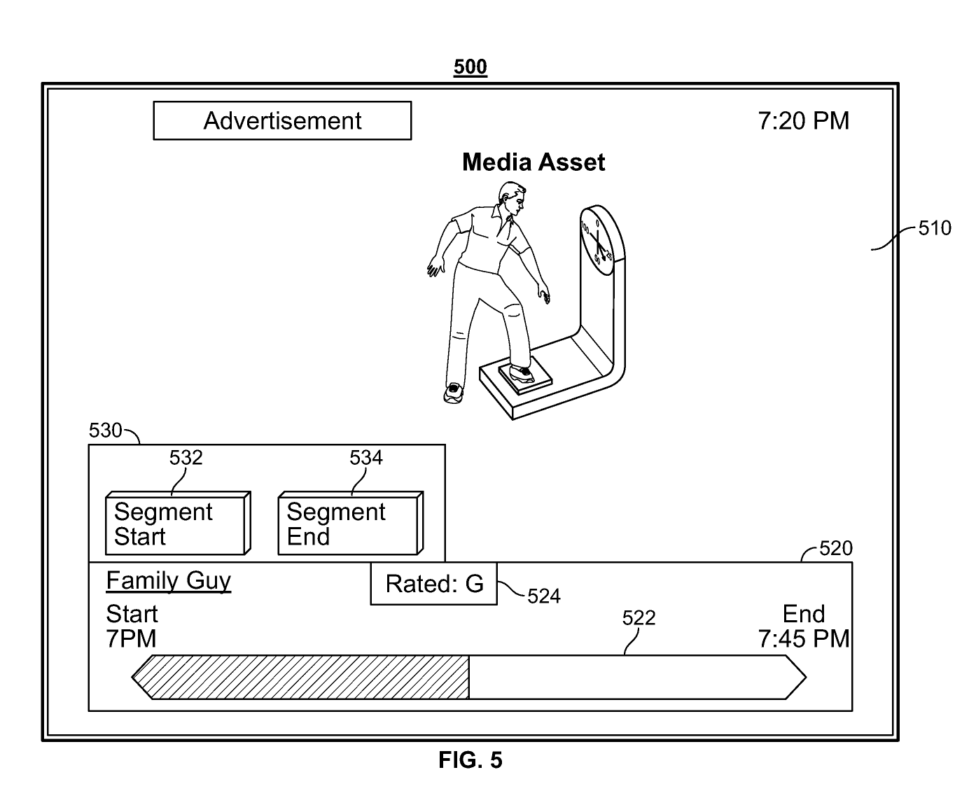

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

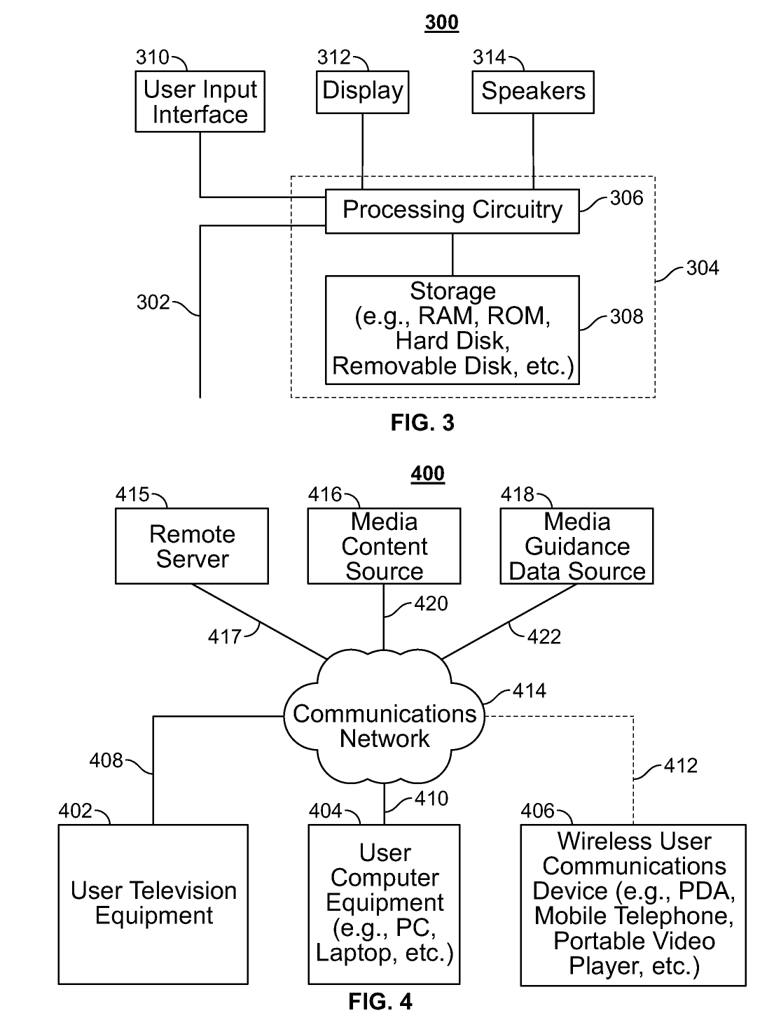

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

In some embodiments, a viewing history may be stored in storage 308 for a user. The viewing history may include indications of which media assets have been viewed by a given user. The viewing history may also include, for each media asset, which portion or portions have or have not been viewed by the user. In some implementations, the viewing history may include indications of which users in a group of users have seen or viewed a media asset or a particular segment of a media asset. The group of users may be users in a certain geographical location (e.g., in the same home) or users that are associated with each other on a social network.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. User input interface 310 may include keys or displayed options that enable a user to instruct control circuitry 304 to perform a fast-access playback operation (e.g., a skip commercial operation or jump segment operation). Specifically, each key or option displayed on user input interface 310 may correspond to a different fast-access playback operation. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Each user of the user equipment devices may be associated with different users in a crowd of users. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. Media guidance application data may include a data feed that includes messages from a plurality of users in a crowd. The messages in the data feed may be posted by the users in the crowd onto a social network, a blog, a news feed, a website or any other medium in which multiple users may provide messages. In some implementations, the messages may include information that identifies positions of segments included in a media asset as well as identifications of the media asset. The messages may be posted by each of the users to the social network, blog, news feed or website automatically or manually. The messages may be generated by user equipment 300 associated with each user in response to detecting when the respective user started and stopped a fast-access playback operation through a given media asset. Specifically, the segment position identified by each message may be based on a playback position when the user requested a fast-access playback operation to be performed and when the user requested that the fast-access playback operation be stopped. In some implementations, the segment may correspond to a commercial segment of a media asset through which the user performed a fast-forward operation. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of remote server 415. When executed by control circuitry of remote server 415 (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, access to messages posted by users in a crowd, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, control circuitry 304 (of a user equipment device or remote server 415) may retrieve a media asset (or portion of the media asset) from storage 308. Control circuitry 304 may present the retrieved media asset and receive a user request to perform a fast-access playback operation (e.g., fast-forward). Control circuitry 304 may store, as a starting position of a segment, a current playback position at the time the request to perform the fast-access playback operation was received. Control circuitry 304 may monitor a position within the media asset during the fast-access playback operation. In response to receiving a request to stop the fast-access playback operation, control circuitry 304 may automatically store, as the ending position of the segment, the playback position monitored when the request to stop was received. For example, when the segment is a commercial, control circuitry 304 may automatically determine when the user requested to fast-forward or rewind through the commercial segment and store the starting and ending times of the fast-forward or rewind operations as the positions that identify the location of the commercial. Control circuitry 304 (e.g., of a user equipment device) may generate a message that includes an identification of the media asset and segment and transmit that information to remote server 415.

The above and below described embodiments pertain to skipping or identifying segments of a media asset that are commercial segments or non-plot segments. However, this description is similarly applicable to segments that are plot segments or portions of a media asset of interest to the user or not of interest to the user. For example, a user in a crowd of users may identify or mark a segment of a media asset that includes undesirable content (e.g., the credits or uninteresting discussions). After remote server 415 receives a predetermined number of messages from users marking a similar segment, remote server 415 may derive or compute the starting and ending positions of the segment with the undesirable content. After another user requests access to the media asset, the user may playback the media asset. Control circuitry 304 may receive a user input requesting to skip the segment (e.g., with the undesirable content) and in response control circuitry 304 may stop current playback just prior to the start of the segment and resume playback from a point substantially near the ending position of the segment identified by remote server 415.

In some embodiments, a user in a crowd of users may identify or mark a segment of a media asset that includes interesting content (e.g., the plot twist portion of the media asset). After remote server 415 receives a predetermined number of messages from users marking a similar segment, remote server 415 may derive or compute the starting and ending positions of the segment with the interesting content. After another user requests access to the media asset, the user may playback the media asset. Control circuitry 304 may receive a user input requesting to skip to the segment (e.g., with the interesting content) from any playback position within the media asset. In response control circuitry 304 may stop current playback of the media asset and resume playback from a point substantially near the starting position of the segment identified by remote server 415. After the ending position of the segment is reached, control circuitry 304 may, automatically or in response to further user input, terminate playback, continue playback from that point, or resume playback from the playback position of the media asset corresponding to when the user request to skip to the segment was received.

Remote server 415 may store the information in a database. After a predetermined number of messages have been received, remote server 415 may process the information stored in the database to determine the position of the segment within the media asset and make that information available to a user who requests a skip or jump segment operation be performed.

In some embodiments, a remote server 415 coupled to communications network 414 may host a website, social network, blog and/or news site. Remote server 415 may include the same or similar circuitry or components as control circuitry 304. A crowd of users may post messages to remote server 415 that identify a media asset and positions of a segment(s) within the media asset. Remote server 415 may process the received messages to identify starting and/or ending position(s) of the segment within the media asset. For example, remote server 415 may compute an average of the starting positions of the segment identified by each of the messages and an average of the ending positions of the segment identified by each of the messages. Remote server 415 may store the identification of the segment (e.g., the average of the starting positions and the average of the ending positions) as information that is made available to a user equipment device 300 during, before, or after a fast-access playback operation. User equipment device 300 may use the information received from remote server 415 to automatically, or in response to a user request, skip over or jump through the segment of the media asset during playback. Skip or jump should be understood to mean stop a normal playback operation at a certain time point or position within the media asset where a segment begins and resume normal playback at another time point or position that follows the ending position of the segment (in case of a forward skip or jump) or follows the starting position of the segment (in case of a reverse skip or jump).

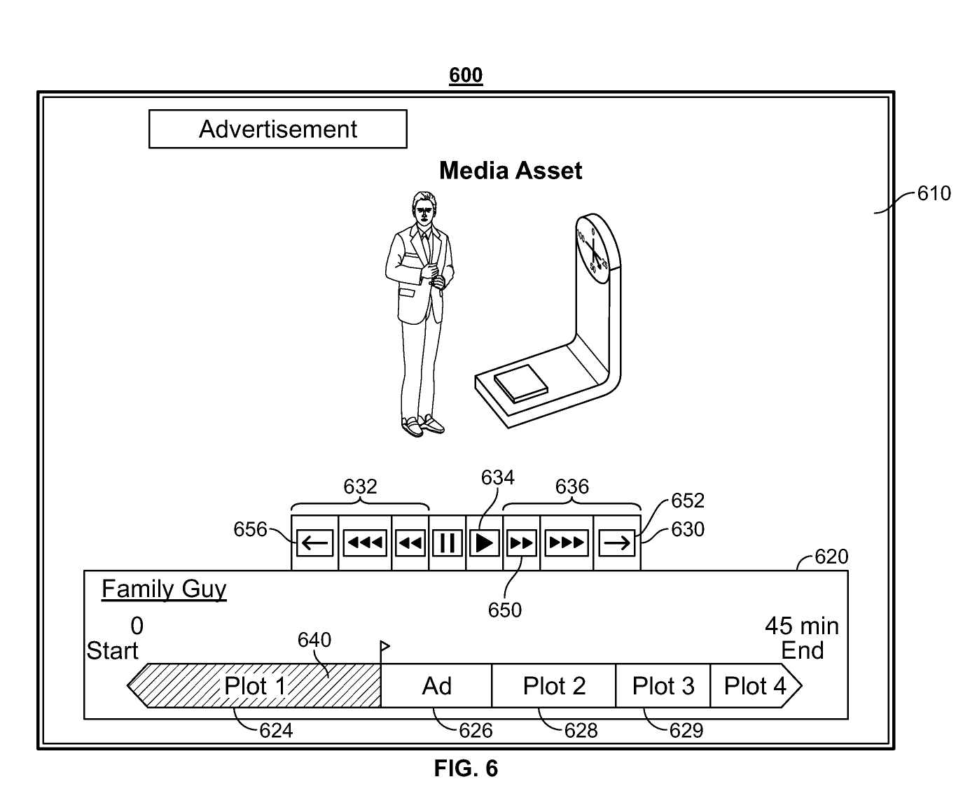

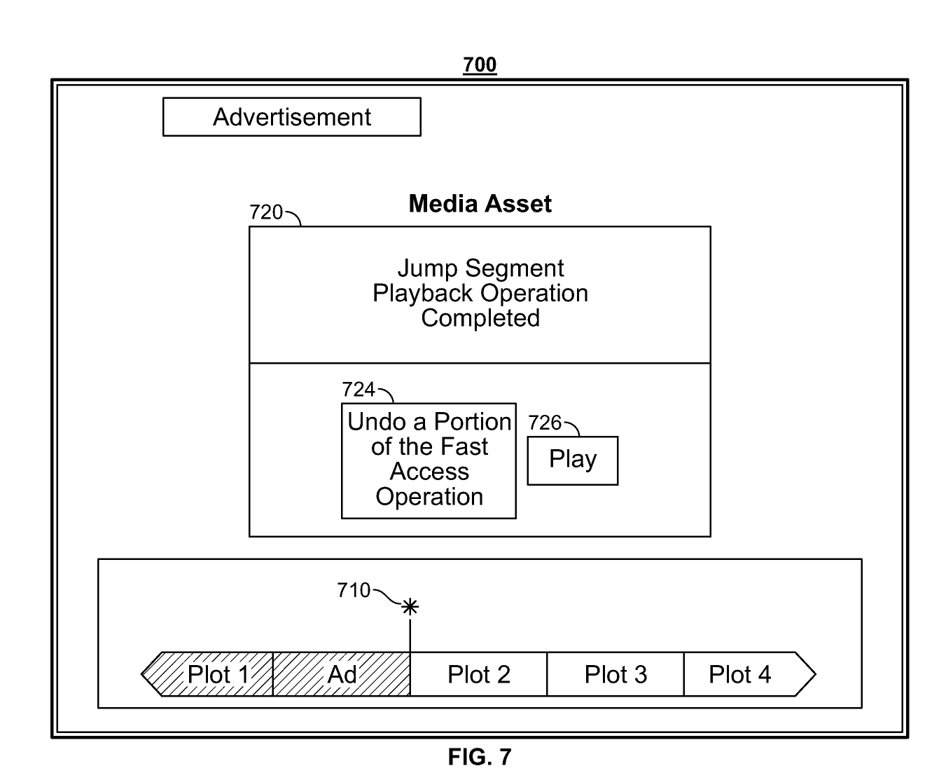

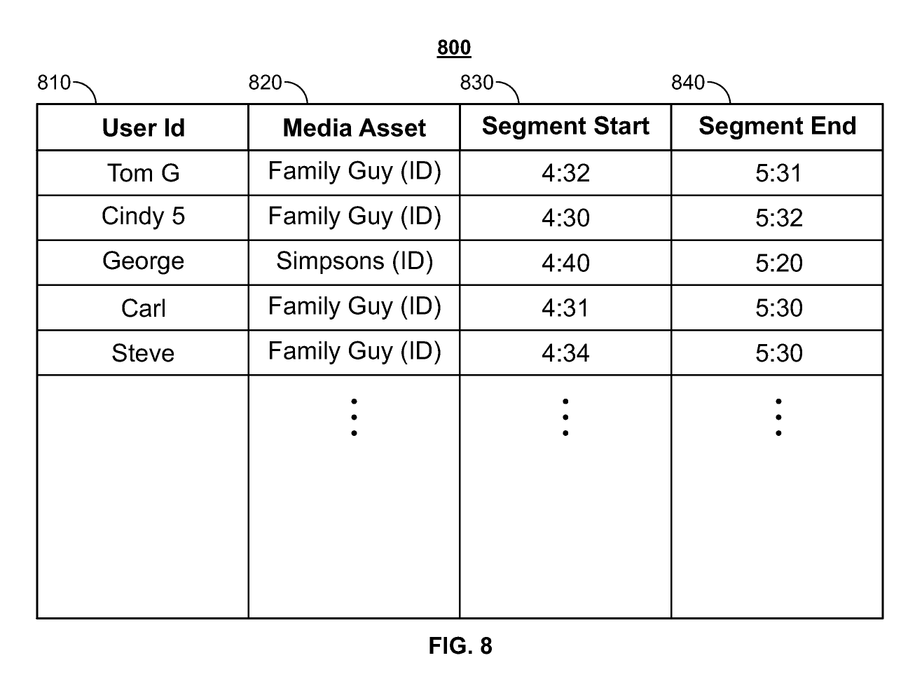

FIG. 5 shows an illustrative display screen 500 of segment identification being performed by a user in a crowd of users in accordance with an embodiment of the invention. The crowd of users may be users that have consumed the media asset displayed in screen 500 before a user who requests a skip or jump segment playback operation in FIGS. 6 and 7. Screen 500 includes a media asset 510, an information overlay 520, and a segment identification region 530.

The media asset displayed in screen 500 may be a linear or non-linear media asset. For example, in some implementations, the media asset may be a live broadcast of an event. A user in the crowd may be consuming the media asset and provide input to control circuitry 304 requesting additional information. In response, control circuitry 304 may generate for display information overlay 520. Information overlay 520 may include any information identifying or describing the media asset (e.g., a title, detailed description, content rating, etc.) and a transport bar 522. Transport bar 522 may indicate to the user a current position within the media asset relative to a start and end time of the media asset.

In some embodiments, starting and ending positions of a segment within the media asset may automatically be identified and stored by control circuitry 304 in response to receiving user input requesting a fast-access playback operation to be performed. In particular, while accessing media asset 510, control circuitry 304 may receive a user input requesting a mark segment or fast-access playback operation to be performed. For example, control circuitry 304 may receive a user request to mark a segment, fast-forward or rewind through a portion of the media asset. In response, control circuitry 304 may store an indication of a playback position at the time the user request was received. For example, the current playback position may correspond to four minutes after start of the media asset playback and the user request to perform the fast-forward operation may be received at the four minute mark. Accordingly, control circuitry 304 may store an indication that the request to perform the fast-access playback operation was received at the four minute mark (e.g., four minutes from the start of the media asset). Control circuitry 304 may automatically store this indication as a starting position of the segment of the media asset.

Control circuitry 304 may monitor playback positions within media asset 510 while the mark segment or fast-access playback operation is being performed. In response to receiving a user request to stop performing mark segment or the fast-access playback operation, control circuitry 304 may determine the playback position being monitored at the time the request to stop is received. For example, the playback position when the user request to stop the fast-forward operation is received may be at the six minute mark (e.g., six minutes from the start of the media asset). Control circuitry 304 may automatically store this indication as an ending position of the segment of the media asset.

In some embodiments, starting and ending positions of a segment within the media asset may automatically be identified and stored by control circuitry 304 in response to detecting a change in playback characteristics of the media asset. In particular, while accessing media asset 510, control circuitry 304 may monitor audio, video or metadata (e.g., closed-caption information) associated with the media asset. Control circuitry 304 may compute a first state identifier for the monitored audio, video or metadata. In response to detecting a change in a pattern of the audio, video or metadata, control circuitry 304 may automatically determine the current playback position and store the current playback position as the starting position of the segment. In particular, in response to detecting the change in a pattern of the audio, video or metadata, control circuitry 304 may compute a second state identifier corresponding to the new pattern of the audio, video or metadata and automatically determine the current playback position and store the current playback position as the starting position of the segment. Control circuitry 304 may continue monitoring the characteristics of the audio, video or metadata and computing state information for the audio, video or metadata. In response to determining that the state information changes from corresponding to the second state identifier to corresponding to the first state identifier, control circuitry 304 may automatically determine the current playback position and store the current playback position as the ending position of the segment.

In some embodiments, the first state identifier may be assigned a value indicating that closed-caption information is being received with the media asset. The second state identifier may be assigned a value indicating that closed-caption information is not being received with the media asset. In response to detecting a change from receiving closed caption information to not receiving closed caption information, control circuitry 304 may determine the start of a new segment (e.g., the start of a commercial break) and store the starting position of the segment as the playback position at the playback time the change was detected. Subsequently, in response to detecting a change from not receiving closed caption information to again receiving closed caption information, control circuitry 304 may determine the end of the new segment (e.g., the end of the commercial break) and store the ending position of the segment as the playback position at the playback time the change was detected.

In some embodiments, the first state identifier may be assigned a value indicating a first volume level of the media asset being accessed. The second state identifier may be assigned a value indicating a second volume level of the media asset being accessed. The second volume level may be greater than the first volume level which typically is the case when media assets enter a commercial break. In response to detecting a change from the first volume level to the second volume level, control circuitry 304 may determine the start of a new segment (e.g., the start of a commercial break) and store the starting position of the segment as the playback position at the playback time the change was detected. Subsequently, in response to detecting a change from the second volume level back to the first volume level, control circuitry 304 may determine the end of the new segment (e.g., the end of the commercial break) and store the ending position of the segment as the playback position at the playback time the change was detected.

In some embodiments, the first state identifier may be assigned a value indicating a first video brightness level of the media asset being accessed. The second state identifier may be assigned a value indicating a second video brightness level of the media asset being accessed. The second video brightness level may be greater than the first video brightness level. In response to detecting a change from the first video brightness level to the second video brightness level, control circuitry 304 may determine the start of a new segment (e.g., the start of a commercial break) and store the starting position of the segment as the playback position at the playback time the change was detected. Subsequently, in response to detecting a change from the second video brightness level back to the first video brightness level, control circuitry 304 may determine the end of the new segment (e.g., the end of the commercial break) and store the ending position of the segment as the playback position at the playback time the change was detected.

In some embodiments, a segment within the media asset may be manually identified by the user. Specifically, the user in the crowd consuming the media asset may manually identify the segment starting and ending positions. Specifically, while the user in the crowd is consuming the media asset, the user in the crowd of users may indicate to control circuitry 304 the desire to identify a segment without requesting a fast-access playback operation to be performed. The segment identified by the user may be a commercial segment, a plot segment, or any other segment of the media asset that is of interest (has desirable content) or not of interest (has undesirable content) to the user. In response, control circuitry 304 may display segment identification region 530. For example, the user may wish to continue watching the segment (e.g., the commercial or advertisement) but may desire to identify the segment without performing a mark segment or fast-access playback operation through the segment. In such circumstances, the user may use input interface 310 and press a suitable button requesting to identify a segment of the media asset. In response, control circuitry 304 may display segment identification region 530. In some implementations, control circuitry 304 may display segment identification region 530 persistently throughout presentation of the media asset, at predetermined or user defined intervals (e.g., every 5 minutes), after a commercial break, in response to a user request for information, together with overlay 520, or any combination thereof.

Segment identification region 530 may include a segment start option 532, segment end option 534, and a segment type region (not shown). In response to receiving a user selection of segment start option 532, control circuitry 304 may identify a current playback position within the media asset and store the position in storage 308 as the starting position of the segment. In some implementations, in response to receiving the user selection of option 532, control circuitry 304 may store a position that precedes the current playback position by a predetermined amount of time (e.g., 5-10 seconds) in storage 308. This may be useful to make up for human reaction time delays in providing input that marks the start of the segment. In some implementations, in response to receiving a user selection of segment start option 532, control circuitry 304 may display a prompt and request further input from the user identifying a particular time point of the media asset that corresponds to the starting position of the segment. For example, the user may provide input by typing in numbers that represent a time point of the starting position. Alternatively, the user may provide input by selecting a region of transport bar 522 that corresponds to the starting position of the segment. Control circuitry 304 may receive the user input identifying the starting position and store that input as the starting position of the segment.

In response to receiving a user selection of segment end option 534, control circuitry 304 may identify a current playback position within the media asset and store the position in storage 308 as the ending position of the segment. In some implementations, in response to receiving the user selection of option 534, control circuitry 304 may store a position that precedes the current playback position by a predetermined amount of time (e.g., 5-10 seconds) in storage 308. This may be useful to make up for human reaction time delays in providing input that marks the end of the segment. In some implementations, in response to receiving a user selection of segment end option 534, control circuitry 304 may display a prompt and request further input from the user identifying a particular time point of the media asset that corresponds to the ending position of the segment. For example, the user may provide input by typing in numbers that represent a time point of the ending position. Alternatively, the user may provide input by selecting a region of transport bar 522 that corresponds to the ending position of the segment. Control circuitry 304 may receive the user input identifying the ending position and store that input as the ending position of the segment.

A segment type region (not shown) may include options that allow a user to specify what type of segment is being marked or identified by segment start and end options 532 and 534. For example, the user may select an option that indicates to control circuitry 304 that the segment being identified corresponds to a plot portion or a commercial or advertisement portion. In some implementations, the user may specify that a particular segment corresponds to a given part of the plot. For example, a media asset may be made up of multiple plot segments and the user may uniquely identify starting and ending positions of a given one of those plot segments and what type of segment it is. Specifically, the user may indicate that the segment includes certain music or content characteristics (e.g., genre, predefined or user defined category or other content attributes) and may also assign a name or other identifier as the segment type. In some implementations, the user may specify that a segment being marked includes desirable content, for example by selecting a happy face or selecting a “like” button. Alternatively, the user may specify that a segment being marked includes undesirable content, for example by selecting a sad face or selecting a “dislike” button. Control circuitry 304 may receive the user's identification of the segment type (e.g., whether the segment includes desirable content, undesirable content, specific content, belongs to a certain genre or predefined or user defined category, has certain content attributes, commercial, plot segment, or any combination thereof) and store the segment type for use in generating the message transmitted to remote server 415.

Plot portions should be understood to mean any portion of a media asset that relates to the title (e.g., any portion that is not an advertisement). For example, the plot portion of a music media asset may include the entire music portion. A long music segment may have a commercial interruption and so the commercial does not form part of the music portion or plot portion of the music media asset.

In some embodiments, control circuitry 304 may receive a user input requesting a list of all segments identified in the media asset. The list may include automatically identified segments and/or manually identified segments. Control circuitry 304 may retrieve from storage 308 all segments corresponding to a given media asset. Control circuitry 304 may generate a display that includes a list of all the identified segments. The list may include a visual representation (e.g., a short clip or image) of each identified segment. The visual representation may be presented alongside each identified segment being listed so that multiple visual representations corresponding to different segments may be displayed. Each of the identified segments may include an indication of the corresponding starting and ending positions within the media asset. Each of the identified segments may include an indication of whether the segment was automatically generated or manually generated. Each of the identified segments may include an indication of the type of the segment. The list may be interactive and control circuitry 304 may receive a user selection of one of the segments identified in the list. In response, control circuitry 304 may automatically playback at normal speed the selected segment. Alternatively, control circuitry 304 may request user input or receive user input identifying a type (e.g., genre, category, content attribute, desirable content, undesirable content, plot segment or commercial) of the selected segment, for example, when a segment type was not previously provided. In response to receiving user input identifying what type the segment is, control circuitry 304 may store with the corresponding segment the specified type for use in generating a message for transmission to remote server 415.

Control circuitry 304 may generate a message that includes: the automatically stored starting position or manually identified starting position, e.g., starting position identified by start option 532 being selected; and the automatically stored ending position or manually identified ending position the ending position, e.g., ending position identified by segment end option 834 being selected. Control circuitry 304 may also include in the message a segment type (if one is specified) for the identified segment in the message. Control circuitry 304 may include other information that uniquely identifies the media asset being consumed by the user in the message (e.g., any information included in overlay 520 and/or other information not included in overlay 520). For example, control circuitry 304 may retrieve data that identifies the media asset being consumed from a local or remote media asset schedule information database. For example, control circuitry 304 may include a title or unique alphanumeric sequence as the information that uniquely identifies the media asset being consumed by the user in the message. Control circuitry 304 may retrieve data or information provided by the user in a segment type region and may include that data or information in the generated message.

In some implementations, control circuitry 304 may only include the segment starting position with the segment type information in the message. In some implementations, control circuitry 304 may only include the segment ending position with the segment type information in the message. In some implementations, control circuitry 304 may only include the segment starting position and segment ending position without the segment type in the message. In some implementations, control circuitry 304 may only include the segment starting position without the segment type in the message. In some implementations, control circuitry 304 may only include the segment ending position without the segment type in the message. Control circuitry 304 may transmit the generated message to remote server 415 that collects similar messages from other users in the crowd of users.

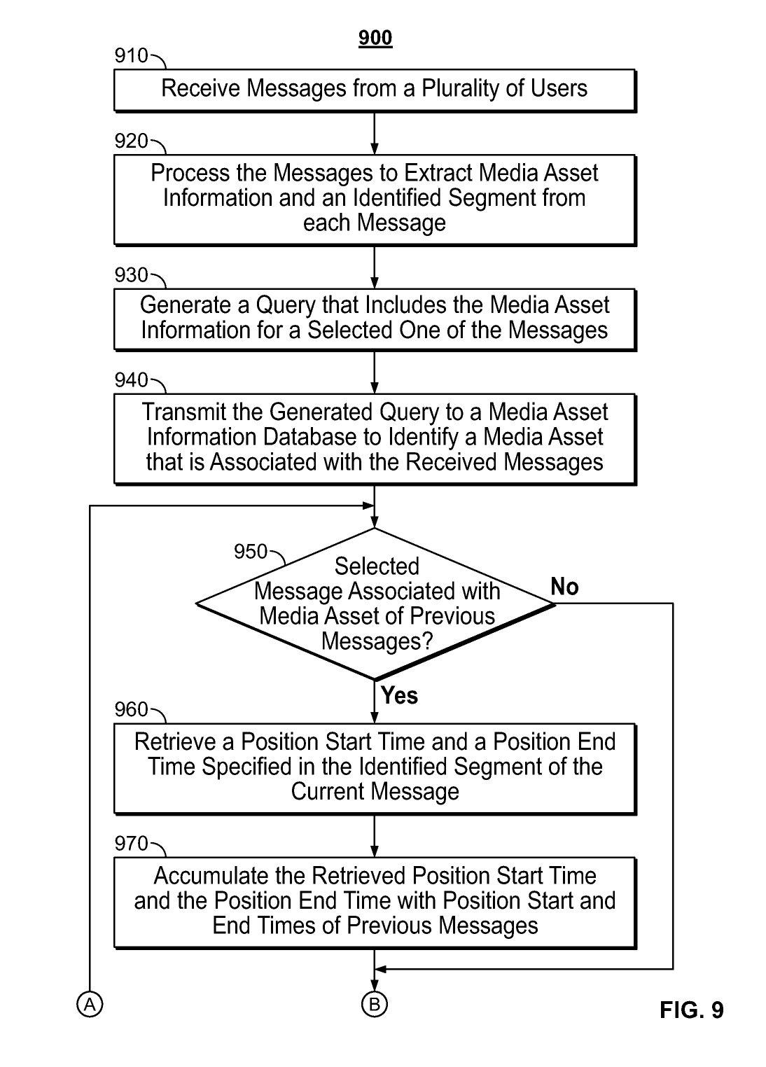

In some embodiments, remote server 415 may collect messages received from various users in a crowd that identify starting/ending positions of segments within a media asset and/or types of those segments. Specifically, as each message is received from a user in the crowd, remote server 415 may process the received message to retrieve a starting position and an ending position and/or type of segment from the message. Remote server 415 may store the retrieved information in a database 800 (FIG. 8). For example, database 800 may include a userID field 810, media asset field 820, segment start field 830, segment end field 840, and/or segment type field (not shown). Remote server 415 may generate and store in database 800 all the extracted information from each received message in a respective database entry. Remote server 415 may extract a user identification (e.g., a user name) from a received message and store that information in field 810 of the entry. Remote server 415 may extract a media asset identification from the received message (e.g., a unique number or title associated with the media asset) and store that information in field 820 of the entry. Remote server 415 may extract a segment starting position (e.g., a start time) from a received message and store that information in field 830 of the entry. Remote server 415 may extract a segment ending position (e.g., an end time) from a received message and store that information in field 840 of the entry. Remote server 415 may extract a segment type (e.g., whether the segment includes desirable content, undesirable content, commercial or plot portion) from a received message and store that information in a corresponding field of the entry.

Remote server 415 may monitor the number of entries a particular media asset receives. For example, remote server 415 may compute how many entries in database 800 have a media asset field 820 that is identical or substantially similar. Remote server 415 may compare the computed number of entries having the identical or substantially similar media asset field 820 with a predetermine threshold. In response to determining that the number exceeds the predetermined threshold, remote server 415 may process segment start field 830 and segment end field 840 for each of the messages having identical or substantially identical fields 820 to determine a segment starting and ending position. For example, in response to determining that a predetermined number of messages (e.g., 100 messages) have been received for a given media asset, control circuitry 304 may collectively process the messages to identify a starting position and an ending position and/or type of the segment within the media asset identified by the messages.

In some embodiments, remote server 415 may monitor the entries stored in database 800 to determine whether any entry corresponds to a trusted user. For example, remote server 415 may generate an SQL query for database 800 to retrieve any entry having a specific username stored as field 810. Specifically, content curators or editors may be among the crowd of users that supply messages to remote server 415. In case remote server 415 receives and stores an entry in database 800 that corresponds to a message received from a content curator or editor, remote server 415 may immediately assign as the starting and ending position of a segment the starting and ending position specified in the database 800 entry corresponding to the message received from the content curator or editor. In such circumstances (e.g., when an entry corresponds to a content curator or editor), remote server 415 may not wait for a predetermined number of messages corresponding to a particular media asset to be received before determining and storing starting and ending positions of a media asset segment. Also, in such circumstances (e.g., when an entry corresponds to a content curator or editor), remote server 415 may not collectively process all messages corresponding to a given media asset to compute a representative starting and ending position of the media asset segment (e.g., the computed average discussed below). Instead, remote server 415 may retrieve the values stored in fields 830 and 840 for the entry having field 810 that matches a content curator or editor username.

In some embodiments, remote server 415 may retrieve starting positions of a segment from each received message by retrieving data stored in segment start field 830 of each entry for each message having an identical or similar media asset field 820. Remote server 415 may compute a representative value (e.g., an average) of all the starting positions included in the messages received from the users in the crowd by computing a representative value (e.g., an average) of all the retrieved data. For example, media asset “Family Guy” may have four entries stored in database 800. Each entry for media asset “Family Guy” may indicate a corresponding segment start position in field 830.

Remote server 415 may retrieve the four segment start times from field 830 of each entry (e.g., 4:32, 4:30, 4:31 and 4:34) and compute an average of those start times (e.g., 4:32). Remote server 415 may store the representative value (e.g., computed average) of the starting positions as the starting position of the segment in the media asset.

In some embodiments, remote server 415 may retrieve ending positions of a segment from each received message by retrieving data stored in segment end field 840 of each entry for each message having an identical or similar media asset field 820. Remote server 415 may compute a representative value (e.g., an average) of all the ending positions included in the messages received from the users in the crowd by computing a representative value (e.g., an average) of all the retrieved data. For example, media asset “Family Guy” may have four entries stored in database 800. Each entry for media asset “Family Guy” may indicate a corresponding segment ending position in field 840. Remote server 415 may retrieve the four segment end times from field 840 of each entry (e.g., 5:31, 5:32, 5:30 and 5:30) and compute an average of those end times (e.g., 5:31). Remote server 415 may store the representative value (e.g., computed average) of the ending positions as the ending position of the segment in the media asset.

In some embodiments, remote server 415 may retrieve types of a segment from each received message by retrieving data stored in type field of each entry for each message having an identical or similar media asset field 820. Remote server 415 may assign a type to the segment identified by the average start/end positions as the type indicated by a majority of the messages that are received. Specifically, remote server 415 may assign a type to the segment identified by the average start/end positions as the type indicated by a majority of the types retrieved from the corresponding fields of the database entries. For example, if more than half of the messages received indicate the segment to correspond to an advertisement portion of the media asset the remaining messages indicate the segment to include a plot portion of the media asset, control circuitry 304 of remote server 415 may assign the segment type as being an advertisement. Similarly, if more than half of the messages received indicate the segment to correspond to an undesirable content of the media asset and the remaining messages indicate the segment to include desirable content of the media asset or lack any indication of type, control circuitry 304 of remote server 415 may assign the segment type as including undesirable content. Similarly, if more than half of the messages received indicate the segment to correspond to desirable content of the media asset and the remaining messages indicate the segment to include undesirable content of the media asset or lack any indication of type, control circuitry 304 of remote server 415 may assign the segment type as including desirable content.

Remote server 415 may store as information associated with the media asset the data that is generated based on the messages received from the crowd of users. Specifically, remote server 415 may store as the information the representative value (e.g., computed average) of the starting position as a segment starting position, the representative value of the (e.g., computed average) ending position as a segment ending position, and/or the computed majority of types as a segment type within the media asset. Control circuitry 304 may deliver or make available the stored information to a user who requests access or retrieval of the media asset associated with the information. Control circuitry 304 of a device used to access the media asset may use the retrieved information to perform a (forward or reverse) skip segment or jump segment playback operation.

FIG. 6 shows an illustrative display screen 600 of a jump segment or skip segment playback operation being performed on a media asset in accordance with an embodiment of the invention. Screen 600 includes a media asset 610, an overlay 620 and playback options region 630. Media asset 610 may be a non-linear media asset that is retrieved from storage. Media asset 610 may be the same or similar as media asset 510 (FIG. 5). For example, media asset 610 may be a recording of a program that was transmitted previously. Media asset 610 may be divided into multiple portions or segments. Specifically, media asset 610 may include plot portions or segments and an advertisement (commercial) portion or segment. In some implementations, media asset 610 may only include plot segments.

Control circuitry 304 may receive a user input requesting display of information about media asset 610. In response, control circuitry 304 may retrieve from storage 308, information about media asset 610 and display the information in overlay 620. Overlay 620 may include a title of media asset 610 and any other suitable information about media asset 610 (e.g., description information, runtime, original scheduled transmission time, etc.). In some implementations, control circuitry 304 may display overlay 620 on top of media asset 610. In some implementations, control circuitry 304 may communicate the information about media asset 610 to a second screen device and instruct the second screen device to display overlay 620. In such circumstances, a full screen display of media asset 610 may continue to be provided on user equipment device 300 while overlay 620 is provided on the second screen device.

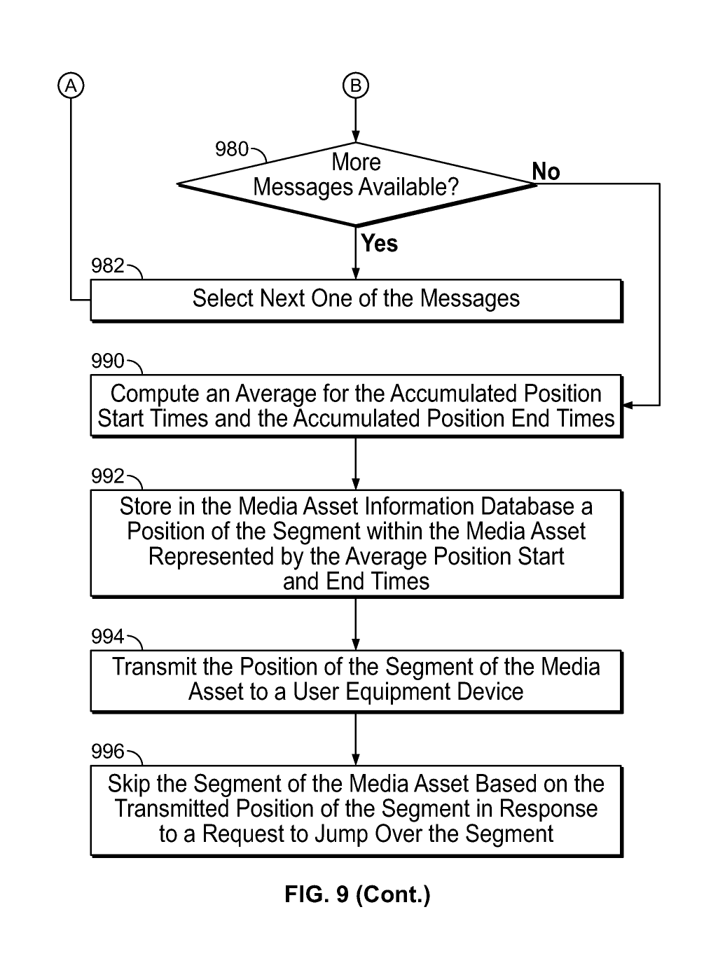

Overlay 620 may include a transport bar that visually depicts or indicates a current playback position within media asset 610 relative to a starting point and ending point of media asset 610. Control circuitry 304 may receive from remote server 415 information that identifies one or more segments of the media asset. For example, remote server 415 may provide to control circuitry 304 information generated based on messages received from a plurality of users that identifies starting positions and ending positions of media asset segments and what type those segments are (e.g., segments with desirable content, undesirable content, genre, category, have certain content attributes, commercials or plot segments). The information may be generated in the manner discussed in connection with FIGS. 5 and 9.

Based on the information received from remote server 415, control circuitry 304 may divide the transport bar into regions that represent the different portions or segments of media asset 610. For example, first region 624 may represent a first plot segment of media asset 610, second region 626 may represent an advertisement segment of media asset 610, third region 628 may represent a second plot segment of media asset 610, and third region 629 may represent a third plot segment of media asset 610. The representations provided in each region may uniquely identify the type of segment to which the region corresponds. The type may be any of the types that the users in the crowd identified for the given segment as discussed above. Specifically, the type of each segment may correspond to the type generated by remote server 415 based on the messages received from the crowd of users. For example, first region 624 may include a title of the first plot segment (e.g., a chapter name) and second region 626 may include an indication that an advertisement is present in that segment of media asset 610 (e.g., a name of a product or service being advertised, a logo, image or video of the advertised product or service). The representations for segments that include desirable content may include a happy face or be shaded in a particular color (e.g., green). The representations for segments that include undesirable content may include a sad face or be shaded in a particular color (e.g., red) different from the color of the representations for desirable content.

The transport bar may include a viewed portion indicator 640. Indicator 640 may shade, visually indicate, or color a region in the transport bar which corresponds to a portion of media asset 610 that has been played back or viewed by the user. Similarly, another indicator (white space) in the transport bar may visually indicate to the user those portions of media asset 610 that have not been viewed or played back by the user. The indications representing viewed and unviewed portions are similarly provided in connection with the transport bar depicted in FIG. 5.

Control circuitry 304 may receive a user input requesting to perform a playback operation on media asset 610. In response, control circuitry 304 may display playback operation options region 630 adjacent to overlay 620. Options region 630 may include various playback options that may be selected to perform a playback operation or a fast-access playback operation. Fast-access playback operations may include playback operations that progress (e.g., move playback of media asset 610 forward in time) or regress (e.g., moves playback of media asset 610 backwards in time) playback of media asset 610. Specifically, fast-access playback operation options 632 may include options that regress playback of media asset 610 and options 636 may include options that progress playback of media asset 610.

In some implementations, options 632 may include a first rate rewind option that, when selected, causes control circuitry 304 to playback media asset 610 backwards in time to a certain point at a faster rate than normal playback speed and a second rate rewind option that, when selected, causes control circuitry 304 to playback media asset 610 backwards in time to a certain point faster than first rate rewind option. Options 632 may include a skip backwards option that, when selected, causes control circuitry 304 to skip to a point that is a predetermined amount of time (e.g., 30 seconds) previous to the current playback position.

In some implementations, options 636 may include a first rate fast-forward option that, when selected, causes control circuitry 304 to playback media asset 610 forward in time to a certain point faster than normal playback speed and a second rate fast-forward option that, when selected, causes control circuitry 304 to playback media asset 610 forwards in time to a certain point faster than first rate fast-forward option. Options 632 may include a skip forwards option that, when selected, causes control circuitry 304 to skip to a point that is a predetermined amount of time (e.g., 30 seconds) later than the current playback position.

In some implementations, a forward skip segment or forward jump segment option 652 may be included. In response to receiving a user selection of option 652, control circuitry 304 may retrieve from storage 308 information that identifies a segment that is adjacent to the current playback position (e.g., the next segment identified in transport bar 620). The information may be information received from remote server 415 generated based on input received from a plurality of users identifying the segment. Control circuitry 304 may determine a starting position and ending position of the adjacent segment identified by the information retrieved from storage 308. Control circuitry 304 may stop playing back media asset 610 and automatically resume playing back media asset 610 at normal playback speed from the ending position of the adjacent segment. For example, the adjacent segment may correspond to an advertisement or commercial. In response to receiving a user selection of option 652, control circuitry 304 may restart playing back the media asset from the end of the advertisement or commercial segment based on the information received from remote server 415.

In some implementations, a skip to segment option (not shown) may be included. In response to receiving a user selection of the skip to segment option, control circuitry 304 may retrieve, from storage 308, information that identifies a segment of the media asset. The segment may be identified and distinguished by control circuitry 304 from other segments based on a type assigned to the segment (e.g., a type indicating the segment as including desirable content). The information may be information received from remote server 415 generated based on input received from a plurality of users identifying the segment. Control circuitry 304 may determine a starting position and ending position of the identified segment with the desirable content identified by the information retrieved from storage 308. Control circuitry 304 may stop playing back media asset 610 and automatically resume playing back media asset 610 at normal playback speed from the starting position of the identified segment. For example, the identified segment may correspond to a plot twist or interesting climax portion of a media asset.

In some implementations, a reverse skip segment or reverse jump segment option 656 may be included. In response to receiving a user selection of option 656, control circuitry 304 may retrieve from storage 308 information that identifies a segment that is adjacent to the current playback position (e.g., the previous segment identified in transport bar 620). The information may be information received from remote server 415 generated based on input received from a plurality of users identifying the segment. Control circuitry 304 may determine a starting position and ending position of the adjacent segment identified by the information retrieved from storage 308. Control circuitry 304 may stop playing back media asset 610 and automatically resume playing back media asset 610 at normal playback speed from the starting position of the adjacent segment. For example, the adjacent segment may correspond to an advertisement or commercial. In response to receiving a user selection of option 656, control circuitry 304 may restart playing back the media asset from the start of the advertisement or commercial segment based on the information received from remote server 415.

Other options that are not discussed that may be included in region 630 include a chapter or segment selection option which enable a user to pick a particular segment to instruct control circuitry 304 to begin playback directly from the selected segment.

In some implementations, control circuitry 304 may display options region 630 on top of media asset 610. In some implementations, control circuitry 304 may communicate with a second screen device and instruct the second screen device to display options region 630 instead. In such circumstances, an uninterrupted display of media asset 610 may continue to be provided on user equipment device 300 while options region 630 is provided on the second screen device.

After control circuitry 304 receives a user selection of option 652 or 656, control circuitry 304 may generate a prompt for the user indicating completion of the requested operation. This informs the user that the request to skip the advertisement or commercial was successful and allows the user to resume normal playback from another segment (e.g., a plot segment).

FIG. 7 shows an illustrative display screen 700 of a (forward or reverse) jump or skip segment operation being completed in accordance with an embodiment of the invention. Screen 700 includes a prompt 720 that indicates to the user that the jump or skip segment operation completed. Control circuitry 304 may generate for display in prompt 720 an undo option 724 and a play option 726.

In response to receiving a user selection of undo option 724, control circuitry 304 may automatically resume playback at normal playback speed from a position that precedes the starting position of the segment (e.g., the playback position at which the user requested a skip or jump segment option). For example, the skip segment operation may be forward skip segment operation that resumes playback from the ending position of the segment identified by the information received from remote server 415. In response to receiving the user selection of undo option 724, control circuitry 304 may automatically rewind the playback position to a point from which the request to perform the forward skip segment was received.

In response to receiving a user selection of play option 726, control circuitry 304 may resume playing back the media asset at a normal playback speed. In some implementations, control circuitry 304 may generate for display in the transport bar a visual indicator 710 that identifies the position within media asset 610 at which the skip or jump operation was completed (e.g., the ending position of the segment).

FIG. 9 is a diagram of a process 900 for identifying a media asset segment position using messages received from a plurality of users in accordance with embodiments of the invention. Specifically, in some implementations, process 900 of FIG. 9 may be a process that the media guidance application may instruct control circuitry 304 to perform. In some implementations, process 900 of FIG. 9 may be a process or instructions stored in an instruction memory of processing circuitry on a remote server and which remote server 415 is configured to perform.

At step 910, messages from a plurality of users are received. For example, remote server 415 may receive communications from user equipment devices 300 of each of a plurality of users. The communications may be transmitted to remote server 415 as email messages, SMS messages, TCP/IP packets, instant messages, messages posted to a social network, or any other form of packet that carries electronic information. The communications may be automatically generated by each user equipment device 300 based on a request from a user of user equipment device 300 to identify a segment or perform a fast-access playback operation.

At step 920, the messages are processed to extract media asset information and an identified segment from each message. For example, remote server 415 may process information stored in each message and extract media asset information (e.g., a program title or unique identifier of a program) stored in the messages and segment information (e.g., starting position and ending position of a segment and/or segment type) stored in the messages.

At step 930, a query that includes the media asset information for a selected one of the messages is generated. Remote server 415 may generate an SQL query that includes the extracted media asset information and transmit the SQL to a media asset database.

At step 940, the generated query is transmitted to a media asset information database to identify a media asset that is associated with the received messages. For example, the query may be transmitted to database 800. Database 800 may be instructed by the query to process field 820 of database 800 to determine whether any of the entries stored in database 800 have data stored in field 820 that matches the media asset information in the generated query. In particular, database 800 may determine whether any previously stored entries in database 800 correspond to a same or similar media asset as the selected message from one of the users.

At step 950, a determination is made as to whether the selected message is associated with a media asset of a previous messages. In response to determining that the selected message is associated with a media asset of a previous message, the process proceeds to step 960, otherwise the process proceeds to step 980. For example, database 800 may return to remote server 415 an indication of whether entries matching the media asset information in the selected message exist and if so, a number of entries that correspond to a media asset that matches the media asset information in the selected message. For example, remote server 415 may generate an SQL query that includes instructions for database 800 to retrieve for each entry in database 800 that corresponds to the media asset identified in the selected message starting and ending positions of the segments identified by the stored entries from fields 830 and 840, respectively and/or segment types of those segments.

At step 960, a position start time and a position end time specified in the identified segment of the selected message is retrieved. For example, remote server 415 may retrieve from the selected message the specified starting and ending position of the segment extracted from the message. Remote server 415 may generate an SQL query or instruction to database 800 to add an entry for the selected message and populate fields of the entry with the media asset information extracted from the selected message and the starting and ending positions of the segment identified in the selected message.

At step 970, the retrieved position start time and the position end time is accumulated with position start and end times of previous messages. For example, remote server 415 may compute a sum of the starting positions retrieved from database 800 that correspond to the media asset information of the selected message and may add to the computed sum the value of the starting position of the segment identified by the selected message. Remote server 415 may compute a sum of the ending positions retrieved from database 800 that correspond to the media asset information of the selected message and may add to the computed sum the value of the ending position of the segment identified by the selected message.

At step 980, a determination is made as to whether more messages are available. In response to determining that more messages are available, the process proceeds to step 982, otherwise the process proceeds to step 990.

At step 982, a next one of the received messages is selected. For example, remote server 415 may select another message from the received plurality of messages for which the segment identification and media asset information has not yet been compared using database 800.

At step 990, an average of the accumulated position start times and the accumulated position end times is computed. For example, remote server 415 may transmit an SQL query to database 800 that includes media asset information that is common to the plurality of messages and a request for number of matches. In response, database 800 may count how many entries in database 800 have fields 820 that match the media asset information in the SQL query and return to remote server 415 the number of entries. This number may represent the total number of messages that correspond to a give media asset. Remote server 415 may divide the computed sum of the starting positions and ending positions by the number of messages to determine the average starting and ending positions of the segment of the media asset.

At step 992, a position of the segment within the media asset represented by the average position start and end times is stored in the media asset information database.

At step 994, the position of the segment of the media asset is transmitted to a user equipment device. For example, remote server 415 may receive a request from a user equipment device 300 for media asset information associated with a given media asset being accessed by user equipment device 300. In response, remote server 415 may retrieve the stored average position start and end times from the media asset information database and transmit the retrieved information to user equipment device 300.

At step 996, the segment of the media asset is skipped based on the transmitted position of the segment in response to receiving a request to jump or skip over the segment. For example, user equipment device 300 may receive a user request to perform a skip or jump segment playback operation, as discussed in FIGS. 6 and 7. In response, user equipment device 300 may retrieve the segment starting and ending position from the information received from remote server 415. User equipment device 300 may automatically stop playback and resume normal playback from the ending position of the segment identified by the retrieved information in the case of a forward skip or jump playback operation request. User equipment device 300 may automatically stop playback and resume normal playback from the starting position of the segment identified by the retrieved information in the case of a reverse skip or jump playback operation request.

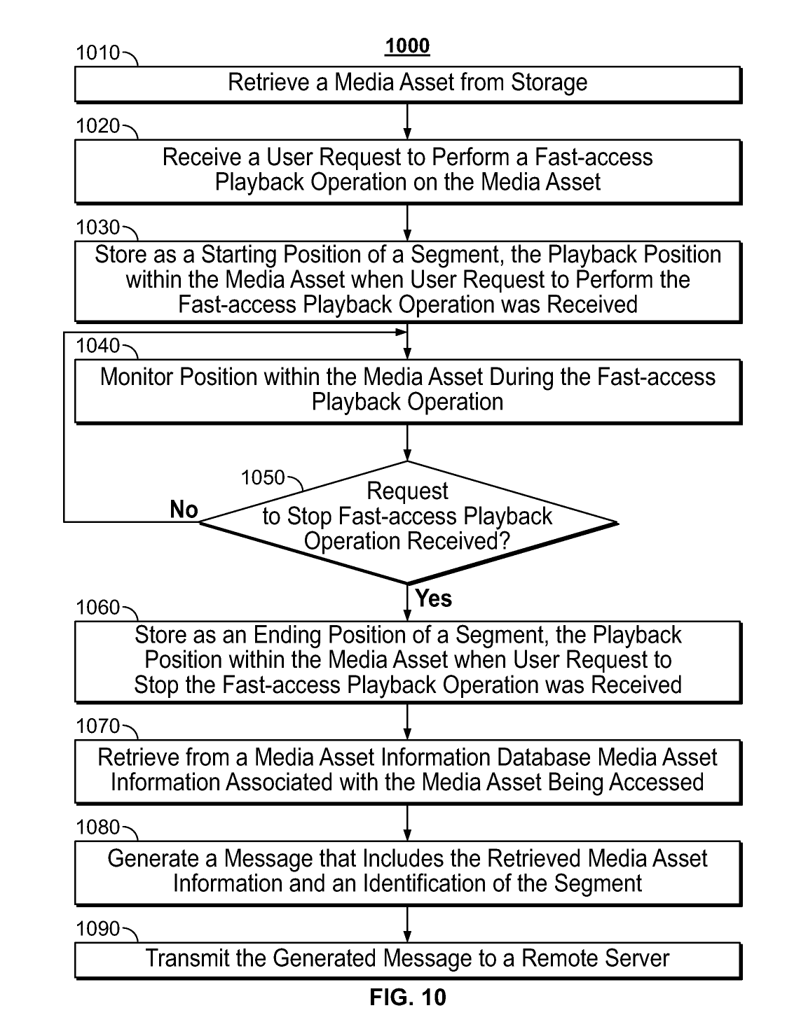

FIG. 10 is a diagram of a process 1000 for jumping over a media asset segment based on information generated using messages received from a plurality of users in accordance with embodiments of the invention. Specifically, in some implementations, process 1000 of FIG. 10 may be a process that the media guidance application may instruct control circuitry 304 to perform. In some implementations, process 1000 of FIG. 10 may be a process or instructions stored in an instruction memory of processing circuitry on a remote server and which remote server 415 is configured to perform.

At step 1010, a media asset is retrieved from storage. For example, control circuitry 304 of user equipment device 300 may receive a user selection of a program listing or media asset listing corresponding to a non-linear program or media. Control circuitry 304 may retrieve data associated with the selected listing to identify the storage location of the media or program. Specifically, in case the media asset is locally recorded content, the data may include a pointer to a storage location on a local storage device that identifies the starting address of the media asset stored. In case the media asset is an on-demand media asset provided by a remote server, the data may include a network address (e.g., IP address) that identifies the storage location on a remote server and the specific file that includes the content of the media asset. Remote server 415 may stream or transmit the media asset back to control circuitry 304 over the network.

At step 1020, a user request to perform a fast-access playback operation on the media asset is received. For example, control circuitry 304 may receive a user input from input interface 310 requesting that the fast-access playback operation be performed (e.g., a skip or jump segment playback operation). In particular, a user selection of option 652 or 656 (FIG. 6) may be received by control circuitry 304.

At step 1030, the playback position within the media asset when the user request to perform the fast-access playback operation was received is stored as a starting position of a segment.

At step 1040, the position within the media asset during the fast-access playback operation is monitored. For example, control circuitry 304 may read and display contents of the media asset at an accelerated rate corresponding to the fast-access playback operation and may continuously monitor the playback position of the fast-access playback operation.

At step 1050, a determination is made as to whether a request to stop the fast-access playback operation is received. In response to determining that a request to stop is received, the process proceeds to step 1060, otherwise the process proceeds to step 1040. For example, the user request to stop may be received as a selection of play option 634 which instructs control circuitry 304 to resume playback at normal playback speed.

At step 1060, the playback position within the media asset when the user request to stop the fast-access playback operation was received is stored as an ending position of the segment.

At step 1070, media asset information associated with the media asset being accessed is retrieved from a media asset information database. For example, control circuitry 304 may query a media asset database stored in storage 308 to retrieve media asset information for the currently accessed media asset. In response, the media asset database may return to control circuitry 304 a title, description, unique identifier or any other media asset information associated with the currently accessed media asset.

At step 1080, a message that includes the retrieved media asset information and an identification of the segment is generated.

At step 1090, the generated message is transmitted to a remote server. For example, user equipment device 300 may transmit to remote server 415 a message that includes information identifying the media asset being accessed and a segment within the media asset through which a fast-access playback operation was performed (e.g., starting position and ending position of the fast-access playback operation).

It should be understood, that the above steps of the flow diagrams of FIGS. 9 and 10 may be executed or performed in any order or sequence not limited to the order and sequence shown and described in the figures. Also, some of the above steps of the flow diagrams of FIGS. 9 and 10 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for identifying a position of a segment within a stored media asset, the method comprising:
receiving, at a remote server, a plurality of messages from a plurality of users, wherein each message identifies a segment within the media asset through which a fast-access playback operation was performed;
processing the received messages to extract media asset information and the identified segment;
cross-referencing the extracted media asset information of each message with a media asset information database to identify the media asset that corresponds to each of the received messages;
processing the identified segments extracted from each of the plurality of messages to determine a position of the segment within the identified media asset; and
storing in the media asset information database, for the media asset that corresponds to each of the received messages, the position of the segment within the media asset.

2. The method of claim 1, wherein the remote server is associated with a social network, website, blog or news site.

3. The method of claim 1, wherein the position of the segment includes a start time and end time of the segment within the media asset.

4. The method of claim 1, wherein the segment identified by each message is a segment corresponding to an advertisement or commercial, and wherein the fast-access playback operation is a fast-forward or skip forward playback operation that plays back the advertisement or commercial at a rate greater than normal playback speed.

5. The method of claim 1, wherein processing the identified segments comprises:
determining a starting position of the fast-access playback operation and an ending position of the fast-access playback operation of each of the extracted identified segments; and
computing a representative start time and a representative end time based on the determined starting positions and ending positions of each of the extracted identified segments; wherein
the position of the segment is determined to be the representative start time and representative end time of the segment within the media asset.

6. The method of claim 5, wherein computing the representative start time comprises computing a first average of the starting positions of each of the extracted identified segments, and wherein computing the representative end time comprises computing a second average of the ending positions of each of the extracted identified segments.

7. The method of claim 1 further comprising transmitting the position of the segment within the media asset stored in the media asset information database to a user equipment device, wherein the user equipment device performs a fast-access playback operation through the segment of the media asset based on the transmitted position.

8. The method of claim 1, wherein each of the received messages is associated with a different user in the plurality of users.

9. The method of claim 1, wherein one of the plurality of messages is automatically generated by a user equipment device associated with a user in response to receiving a request to perform the fast-access playback operation while the user views the media asset.

10. The method of claim 1, wherein:
segment identified by each message includes a starting position of the fast-access playback operation and an ending position of the fast-access playback operation;
the starting position is stored in the message in response to receiving a user request to perform the fast-access playback operation; and
the ending position is stored in the message in response to receiving a user request to stop the fast-access playback operation being performed.

11. A system for identifying a position of a segment within a stored media asset, the system comprising:
control circuitry configured to:
receive, at a remote server, a plurality of messages from a plurality of users, wherein each message identifies a segment within the media asset through which a fast-access playback operation was performed;
process the received messages to extract media asset information and the identified segment;
cross-reference the extracted media asset information of each message with a media asset information database to identify the media asset that corresponds to each of the received messages;
process the identified segments extracted from each of the plurality of messages to determine a position of the segment within the identified media asset; and
store in the media asset information database, for the media asset that corresponds to each of the received messages, the position of the segment within the media asset.

12. The system of claim 11, wherein the remote server is associated with a social network, website, blog or news site.

13. The system of claim 11, wherein the position of the segment includes a start time and end time of the segment within the media asset.

14. The system of claim 11, wherein the segment identified by each message is a segment corresponding to an advertisement or commercial, and wherein the fast-access playback operation is a fast-forward or skip forward playback operation that plays back the advertisement or commercial at a rate greater than normal playback speed.

15. The system of claim 11, wherein the control circuitry is further configured to:
determine a starting position of the fast-access playback operation and an ending position of the fast-access playback operation of each of the extracted identified segments; and
compute a representative start time and a representative end time based on the determined starting positions and ending positions of each of the extracted identified segments; wherein
the position of the segment is determined to be the representative start time and representative end time of the segment within the media asset.

16. The system of claim 15, wherein the control circuitry is further configured to compute a first average of the starting positions of each of the extracted identified segments, and compute a second average of the ending positions of each of the extracted identified segments.

17. The system of claim 11 further comprising communication circuitry configured to transmit the position of the segment within the media asset stored in the media asset information database to a user equipment device, wherein the user equipment device performs a fast-access playback operation through the segment of the media asset based on the transmitted position.

18. The system of claim 11, wherein each of the received messages is associated with a different user in the plurality of users.

19. The system of claim 11, wherein one of the plurality of messages is automatically generated by a user equipment device associated with a user in response to receiving a request to perform the fast-access playback operation while the user views the media asset.

20. The system of claim 11, wherein:
segment identified by each message includes a starting position of the fast-access playback operation and an ending position of the fast-access playback operation;
the starting position is stored in the message in response to receiving a user request to perform the fast-access playback operation; and
the ending position is stored in the message in response to receiving a user request to stop the fast-access playback operation being performed.

21-30. (canceled)
